(19) United States
(12) Patent Application Publication
(10) Pub. No.: US 2010/0078266 A1
(43) Pub. Date: Apr. 1, 2010

(54) ELEVATOR SYSTEM AND CONTROL METHOD THEREOF

(76) Inventor: Sung Sik Choi, Goyang (KR)

Correspondence Address: LRK Patent Law Firm, 1952 Gallows Rd, Suite 200, Vienna, VA, 22182, US

(21) Appl. No.: 12/594,151

(22) PCT Filed: Oct. 31, 2007
(86) PCT No.: PCT/KR07/05420

§ 371 Date: Sep. 30, 2009

(30) Foreign Application Priority Data
Apr. 2, 2007 (KR) 10-2007-0032386
Jun. 8, 2007 (KR) 10-2007-0055803

(51) Int. Cl. B66B 1/24; B66B 1/18; B66B 1/20; B66B 9/00

(52) U.S. Cl. 187/247; 187/395; 187/382; 187/383; 187/249

(57) ABSTRACT

An improved elevator system and control method thereof is provided for effectively scheduling elevator cars and reducing hoistway spaces. The elevator system of the present invention includes at least one hoistway and at least two elevator cars operating independently in the hoistway. The elevator system schedules multiple elevator cars for multiple calls on the basis of information obtained by analyzing various signals provided from the button panels installed at elevator cars and elevator entrances of a building, thereby improving operation efficiency of the elevator system.

### TECHNICAL FIELD

The present invention relates to an elevator system and, in particular, to an improved elevator system and control method thereof that enables effectively scheduling elevator cars and reducing hoistway spaces.

### BACKGROUND ART

An elevator system is a transport system used to move goods and people vertically.

As schematically shown in FIG. 1, an elevator system includes an in-car button panel 10 provided inside each elevator car, an up/down button panel 20 provided at each floor of a building, a controller 30, and an elevator driving unit 40.

The in-car button panel 10 is basically provided with floor buttons, a door close, and a door open button; and the up/down button panel 20 is provided with an up and down buttons for passengers indicate their desired direction of travel. The controller 30 is electrically connected to the in-car button panel 10, up/down button panel 20, and the elevator driving unit 40 so as to control operation of the elevator driving unit 40 in accordance with signals received from the panels 10 and 20.

Typically in the prior art elevator systems, the passengers awaiting pick-up select a desired travel direction on the up/down button panel 20. If a direction button is pushed, the up/down button panel 20 sends a direction signal to the controller 30, and the controller 30 outputs a driving signal generated on the basis of the direction signal to the elevator driving unit 40.

Although it is not a significant issue in low story buildings, elevator scheduling is a well-know problem in a high story building with large transient passengers.

In some conventional elevator systems, the controller assigns a nearest elevator car to the floor of which the up/down button panel transmits the directional signal. In a case, however, when receiving the direction signal from more than two floors, the controller assigns the elevator cars to the floor firstly transmitted the direction signal in their running direction, whereby the passengers on the floor transmitted the direction signal must wait the elevator car in a long time. Such scheduling problem becomes much significant when at least one elevator car stop operating for repair or security examination, resulting in loss in terms of time, space, and energy.

Also, the conventional elevator systems have drawbacks in that the elevator scheduling is performed without consideration of passenger's traffic patterns and disabled people.

For example, in order for a blind person to find a target floor button in the elevator car, he/she must search the target floor button by fumbling over the in-car button panel. Also, since the in-car button panels and the up/down button panels are installed at a relatively high height, disabled person on wheelchair are unreachable to button panels.

### DISCLOSURE OF INVENTION

### Technical Problem

The present invention has been made in an effort to solve the above problems, and it is an object of the present invention to provide an elevator system and control method thereof that is capable of improving operation efficiency of the elevator system and reducing spaces for the elevator system in a building by scheduling elevator cars in consideration of signals sent by in-car button panels and up/down button panels.

It is another object of the present invention to provide an elevator system and control method thereof that enables selecting a target floor using both in-car button and outside up/down button panels.

It is another object of the present invention to provide an elevator system and control method thereof that is capable of scheduling elevator cars in consideration of expected load input through up/down button panels provided at entrances for every floor.

It is another object of the present invention to provide an elevator system and control method thereof that is capable of optimally scheduling elevator cars on the basis of an average cargo at each floor.

### Technical Solution

In accordance with an aspect of the present invention, the above and other objects are accomplished by an elevator system. The elevator system includes at least one hoistway and at least two elevator cars operating independently in the hoistway.

Preferably, the hoistway houses a pair of first and second elevator cars, the first car being driven by a first driving unit installed at a roof of the hoistway, and the second elevator car is driven by a second driving unit installed at a bottom of the first elevator car.

Preferably, the elevator system further includes at least one driving unit installed at a roof wall of the hoist way for driving the elevator cars independently.

Preferably, the elevator system further includes a sensing unit installed at each elevator car for sensing a load and speed of the elevator car and interval between the elevator cars housed in the same hoistway; a up/down button panel installed at each elevator entrance for allowing input of a target floor number; an in-car button panel installed at each elevator car for allowing input of a target floor number; and a main control unit for scheduling the elevator cars on the basis of signals input through the up/down button panel, the in-car button panel, and the sensing unit.

Preferably, the elevator system further includes a passenger recognition module installed on the up/down button panel for identifying expected passengers using unique human characteristics and estimating a number of the expected passengers waiting at a same floor by counting inputs by different expected passengers.

### BRIEF DESCRIPTION OF THE DRAWINGS

FIG. 1 is a schematic view illustrating a conventional elevator system.

FIG. 2 is a cross sectional view illustrating an elevator system according to an exemplary embodiment of the present invention;

FIG. 3 is a block diagram illustrating an internal configuration of the elevator system of FIG. 2;

FIG. 4 is a block diagram illustrating a configuration of a main control unit of the elevator system of FIG. 2;

FIG. 5 is a diagram illustrating an auxiliary input panel of an elevator system according to another embodiment of the present invention;

FIG. 6 is a perspective view illustrating an elevator system according to an exemplary embodiment of the present invention; and

FIG. 7 is a flowchart illustrating a method for controlling the elevator system of FIG. 1 according to an exemplary embodiment of the present invention.

### MODE FOR THE INVENTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

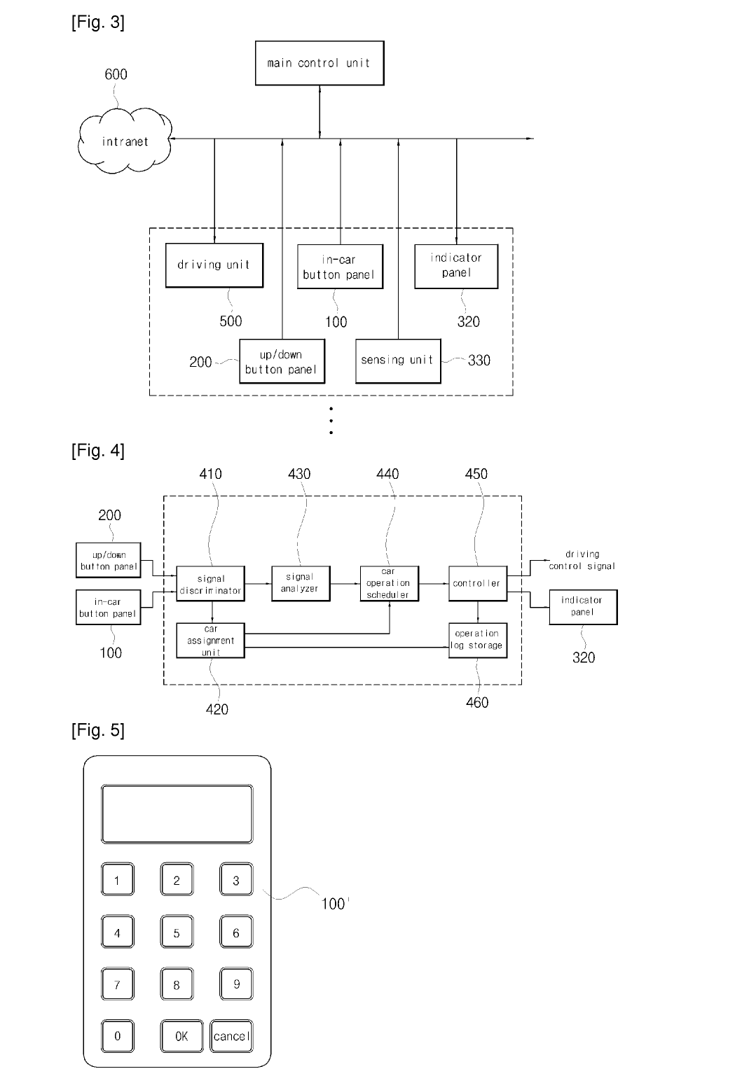

FIG. 2 is a cross sectional view illustrating an elevator system according to an exemplary embodiment of the present invention, and FIG. 3 is a block diagram illustrating an internal configuration of the elevator system of FIG. 2.

Referring to FIGS. 2 and 3, the elevator system includes elevator cars 301 and 302 moving up and down along the respective hoistways 1, an up/down button panel 200 and an outside floor indicator panel 324 installed at each elevator entrance located on each floor of the building, and a main control unit 400. Each elevator car includes an in-car button panel 100, an inside floor indicator panel 322, a sensing unit 330, and a driving unit 500.

The main control unit 400 is electrically connected to the in-car button panel 100, up/down button panel 200, inside and outside floor indicator panels 320, sensing unit 330, and driving unit 500, through an interne 600.

The elevator cars 300-1 and 300-2 can be housed in the same hoistway 1 and driven by the driving unit 500, independently. The elevator system can be configured such that the second elevator car 300-2 is driven by a driving unit 500 installed at the bottom of the first elevator car 300-1.

The main control unit 400 analyzes signals received from the in-car button panels 100 and the up/down button panels 200 and load and distance signals detected by the sensing units 330.

On the basis of the signal analysis results, the main control unit 400 controls the driving units 500 to drive the first and second elevator cars 300-1 and 300-2 independently. The driving units 500 can drive the respective elevator cars 300-1 and 300-2 in opposite directions (i.e. in upward and download directions) or same direction at different speeds.

In this embodiment, each sensing unit 330 senses a load on the elevator car and transmits a load signal to the main control unit 400. In a cast that a few calls are received from different floors and the first elevator car 300-1 is determined empty on the basis of the load signal, the main control unit 400 controls the first elevator car 300-1 to stop at the call nearest to the final destination floor in it running direction such that the first elevator car 300-1 can quickly arrive at the destination floor, controls the second elevator car 300-2 to stop at the call which the first elevator car 300-1 skips, increases the speed of the second elevator car 300-2 if the distance between the first and second elevator cars 300-1 and 300-2 is greater than a predetermined threshold, and decreases the speed of the speed of the second elevator car 300-2 if the distance between the first and second elevator cars is less than the threshold.

In a case that the first elevator car 300-1 moves directly to the final destination floor on the basis of collected signal, the main control unit 400 controls the second elevator car 300-2 to move quickly to stop at every call.

In another case, the main control unit 400 computes the loads and a number of passengers on the first and second elevator cars 300-1 and 300-2 controls the first and second elevator cars 300-1 and 300-2 to travel in respective sections. Also, the main control unit 400 can control the elevator cars 300-1 and 300-2 to stand by at a specific floor according to the operator's preset configuration.

In this embodiment, it is preferred that more than one final destination floor are secured in the building such that the first elevator car 300-1 can secure its final destination floor even when the second elevator car 300-2 is assigned the highest floor as the target arrival floor.

Each sensing unit 330 is provided with a load sensor 332 for sensing the load of the elevator car, a distance sensor 334 for sensing a distance between the first and second elevator cars 300-1 and 300-2, and a speed sensor (not shown) for sensing the travel speed of the elevator car.

The load sensor 332 is installed at the bottom of the elevator car 300-1 (300-2) for sensing the load on the elevator car and sending the load signal to the main control unit 400.

The distance sensor 334 is installed at the top of the elevator car 300-1 (300-2) for sensing the travel speed of the elevator car and sends the distance signal to the main control unit 400.

The speed sensor is installed outside the elevator car 300-1 (300-2) for sensing the travel speed of the elevator car and sends the speed signal to the main control unit 400.

The main control unit 400 analyzes the distance, speed, and load signals sent by the sensing unit 330 and the call signals sent by the in-car button panel 100 and the up/down button panel 200 integrally, and controls the first and second elevator cars 300-1 and 300-2 to operate in different directions and at different speeds on the basis of the analysis result.

The up/down button panel 200 is installed at each elevator entrance located on each floor of the building and provided with floor buttons, a door open button, and a door close button.

In this embodiment, the up/down button panel 200 can be configured to activate service-available floor buttons and deactivate service-unavailable floors under the control of the main control unit 400. The indicator panel 320 distinguishably shows the activated and deactivated floors for user recognition.

The up/down button panel 200 also can be provided with a fingerprint sensor (now shown) for learning a travel pattern of a specific person by tracking floors at which his/her fingerprint is detected. The up/down panel 200 also can be configured such that a selected floor button can be deselected by pushing in again.

FIG. 4 is a block diagram illustrating a configuration of a main control unit of the elevator system of FIG. 2.

In FIG. 4, the main control unit 400 includes a signal discriminator 410, a car assignment unit 420, a signal analyzer 430, a car operation scheduler 440, a controller 450, and an operation log storage 460.

The elevator system can be provided with auxiliary input panel. FIG. 5 is a diagram illustrating an auxiliary input panel of an elevator system according to another embodiment of the present invention. The auxiliary input panel 100′ is installed at every elevator entrance such that the disabled people can easily input the floor number.

The auxiliary input panel 100′ is provided with a plurality of Braille buttons in order for the blind people to easily input floor number comprising at most 4 digits and confirm or cancel the input floor number. After input the floor number, pushing the confirm button transmits the input signal to the input signal discriminator 410.

The elevator system can be configured such that the service available floors are announced in voice message in response to a specific key input on the auxiliary input panel 100′.

The first elevator car 300-1 can compute its load, travel speed, and travel direction an d determines a next stop on the basis of the computation result.

The up/down button panel 200 can be provided with a timer (not shown) such that an expected arrival time can be configured my manipulating the timer. The timer can be used for controlling the travel speed of the elevator car to some extent.

The timer can be installed at a designated place as well as the elevator entrances such that a specific floor and car arrival time at the floor can be reserved at the designated place. This is useful for formal sendoff and reception for noted persons.

Also, the timer can be implemented within a handheld device such as a cellular phone capable of communication with the main control unit 400 of the elevator system. In this case, a target floor and arrival time of a specific elevator car can be reserved using the handheld device.

That is, each elevator car can be reserved and the reservation can be canceled by registering the target floor and time to the main control unit 400 at a remote place. For example, if it is notified at 11:30 that there is an important sendoff or visitation at 11:50, a specific elevator car can be preoccupied by registering the elevator car and target floor at the time 11:50.

The in-car button panel 100 is preferably installed at a side of an elevator door 310 and provides a plurality of floor buttons of which only the service available floors are activated, a door open and a close button, an emergency stop button, and a call button.

In this embodiment, the in-car button panel 100 and the up/down button panel 200 can be implemented in association with a passenger recognition module (not shown) so as to identify the passengers registered to a passenger database. With the identification of the passengers, the panels 100 and 200 recognize and allow multiple inputs and determine the second input of the same button in a predetermined time as a selection cancel command.

The registered are assigned different weights, (e.g. security levels of access permitted level and access denied level) such that the access to each floor can be controlled according to the passenger's access level.

For example, a passenger is recognized as a present of a company occupying the entire building, the main control unit 400 weighs the signal input by the present and responses to the signal with the highest priority. In another example, specific floors on which research and development parts dealing with classified documents are resided can be controlled such that the persons having a low security level such as visitors do not get down on the floors.

The in-car button panel and up/down button panel exchanges signal with the main control unit 400 through a network.

The main control unit 400 controls the travel of the elevator car in the hoistway 1 in accordance with the signal received from the in-car button panel 100, the up/down button panel 200, and the detection 330.

The control unit 400 analyzes the signals input by the passengers in real time, designates the hoistway 1 and elevator car for a target floor on the basis of the analysis result and the pre-configured operation algorithm, and transmits the driving control signals and information associated with the elevator car to the corresponding elevator car.

In one aspect of the present invention, an elevator car having a low load and nearest to the call in it running direction is pre-assigned for the call. In another aspect of the present invention, the elevator car is pre-assigned for a floor which is frequently selected on the up/down button panel 200. In another aspect of the present invention, an elevator car having a low load and nearest floor called in it running direction is assigned for the call. In another aspect of the present invention, the elevator cars are pre-assigned for the floor of which up/down button panel is frequently manipulated for inputting the calls.

The main control unit 400 is connected to an outside communication network; collects the signals transmitted by the in-car button panels 100, up/down button panels 200, and sensing units 330; generates information on the target floors, load, and distance between the elevator cars; computes the designation order of the hoistways 1 and elevator cars on the basis of the signals according to a predetermined algorithm; and operates the elevator cars in accordance with the designation order.

The main control unit 400 can assign an elevator in consideration of the distances between the floor called and the elevator cars, loads of the elevator cars, and the number of pushing buttons on the up/down button panel 200.

The main control unit 400 can control each elevator car travels in a preset section of the building and can assign different stop floors to the different elevator cars.

For example, assuming that a company A occupies from the 1st to 5th floors, a company B occupies from the 6th to 16th floors, a company C occupies the 17th to 30th floors of 30 story building, and 4 elevator cars operate in this building, three of the elevator cars can be assigned for traveling the floors occupied by the companies A, B, and C, respectively.

In a case that a plurality of hoistways 1 exist and multiple elevator cars operate in each hoistway, the elevator system can be provided with secondary indicator panels (not shown), in addition to the indicator panel 320, for indicating the most available hoistway.

The main control unit 400 includes an input signal discriminator 410, a car assignment unit 420, a signal analyzer 430, a car operation scheduler 440, a controller 450, and an operation log storage 460.

In this embodiment, the input signal discriminator 410 distinguishes the signals received from the outside communication network and generated by the in-car button panel 100 and the up/down button panel 200.

The input signal discriminator 410 can be configured to calculate utilization of the elevator system per passenger in association with the passenger recognition module such that the utilization statics can be used for electric bills.

The car assignment unit 420 assigns the hoistways 1 and elevator cars for the calls on the basis of the signals received from the input signal discriminator 410.

The signal analyzer 430 analyzes the signals received from the input signal discriminator 410 and generates control signals for controlling the operations of the elevator cars 300-1 and 300-2. If it is recognized that a plurality of passengers are expected to get off at the same floor, the signal analyzer 430 counts pushing the same button and transmits the count value to the car operation scheduler 440.

If it is determined that the received signals are generated by the in-car button panel 100 and/or the up/down button panel 200, the signal analyzer 430 send the car operation scheduler 440 the information on the floors at which the passengers get on or off the elevator car.

The car operation scheduler 440 generates driving signals for operating the elevator cars in accordance with the operation order output by the car assignment unit 420 on the basis of the information generated by the signal analyzer 430 and the load of each elevator car and the distance between the elevator cars detected by the sensing unit 330.

The control unit 450 generates an operation control signal for controlling the operation of the elevator car and an indication signal for providing information on the travel of the elevator car to the passengers, the indication signal being transmitted to the indicator panel 320.

The operation log storage 460 stores the information on the operations of the elevator cars 300-1 and 300-2.

The driving unit 500 receives the driving control signal from the main control unit 400 and derives the elevator car. As described above, the driving unit 500 is installed to each elevator car.

The driving unit 500 is preferably implemented with a roped driving mechanism. In this case, the elevator cars housed in the same hoistway are arranged to prevent the elevator cars from interfering with each other.

In another aspect of the present invention, the driving unit 500 is implemented with a motor having a pinion gear and fixed to the elevator car, and a rail installed along the inner wall of the hoistway 1 on which a rack gear is fixed, engaging with the pinion gear.

The indicator panel 320 is provided in the elevator car and the elevator entrances for indicating the travel status of the elevator car, the indicator panel 320 illuminates the floor number at which the elevator car is located on the basis of the control signal from the controller 450. The indicator panel 320 is preferably installed above the elevator doors and is configured to indicate the current location and travel direction of the elevator car.

The elevator car can be provided with more than one indicator panel 320 for indicating the current locations of other elevator cars. The indicator panel 320 can be configured such that the service available floor numbers are activated and the service unavailable floor numbers are deactivated, thereby guiding the passengers to appropriate hoistways and elevator cars.

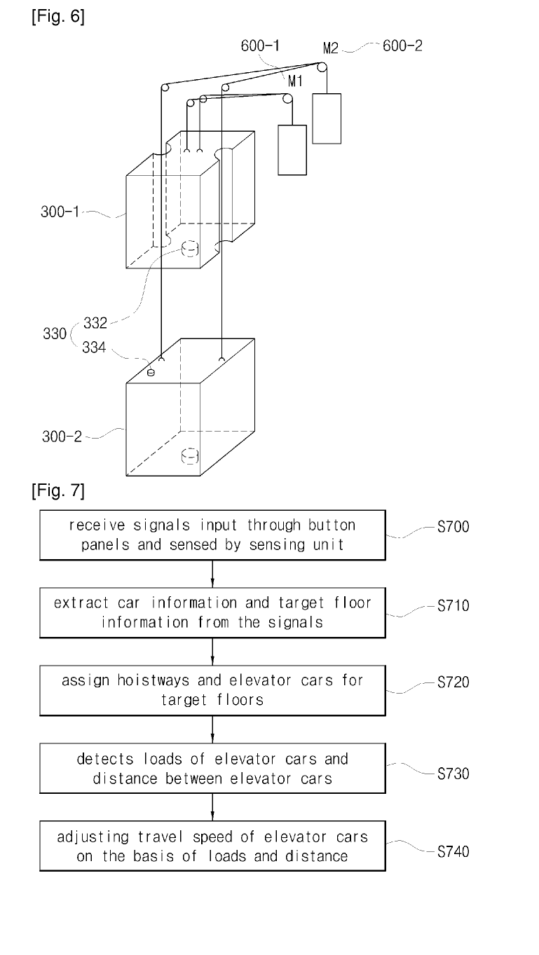

FIG. 6 is a perspective view illustrating an elevator system according to an exemplary embodiment of the present invention.

Referring to FIG. 6, the elevator system includes a first elevator car 300-1 and a second elevator car 300-2 that are vertically arranged and suspended from the first and second driving units 600-1 and 600-2 by means of ropes so as to operate independently.

In order to vertically arrange the first and second elevator cars 300-1 and 300-2, the first elevator car 300-1 is designed to have curvatures through which the ropes for suspending the second elevator car 300-2 pass. In order to stably lift the second elevator car 300-2, the second driving using is provided with a pair of sheaves around which the rope attached to the second elevator car 300-2 are looped.

An operation of the above-structured elevator system is described hereinafter in detail.

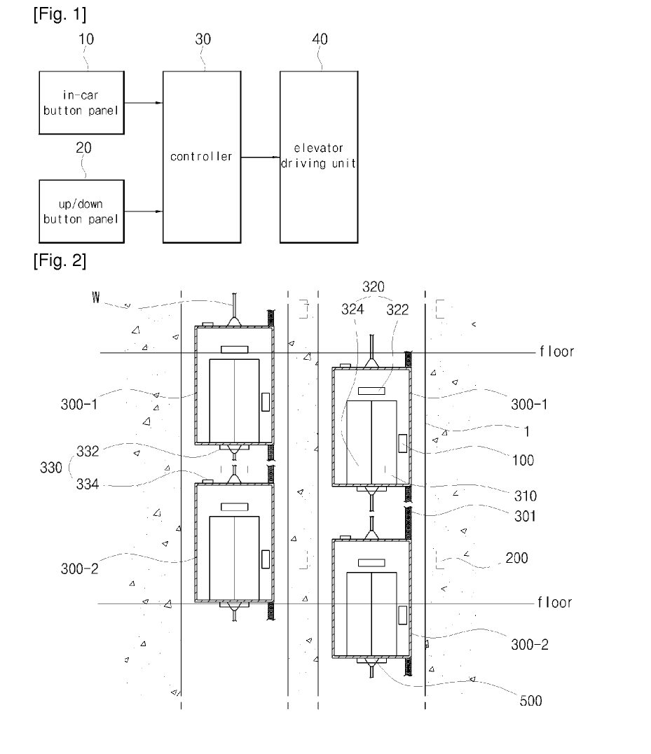

FIG. 7 is a flowchart illustrating a method for controlling the elevator system of FIG. 1 according to an exemplary embodiment of the present invention.

Referring to FIG. 7, the main control unit of the elevator system receives signals input through the in-car button panels and the up/down button panels and sensed by the sensing unit at step S700 and extracts car information including the loads, travel directions, and speeds of the elevator cars, and target floor information including get-on and get-off floors from the signals at step S710. Next, the main control unit assigns the hoistways and elevator cars for the target floors according to the analysis result on the car information and the floor information at step S720. Next, the main control unit calculates the loads of the elevator cars and distance between the elevator cars on the basis of the signals transmitted by the sensing units of the elevator cars at step S730 and controls the travel speeds of the elevator cars on the basis of the calculated loads of the elevator cars and the distance between the elevator cars at step S740.

At step S700, the operator configures the hoistways and elevator cars to operate, operation priorities of the hoistways and elevator cars, and elevator assignment algorithm including reserved assignment processing, through the input signal discriminator 410.

Also, it is possible to set up, step S700, an expected arrival time of the elevator car to a target floor and notify the passengers of the expected arrival time.

At step S710, the input signal discriminator 410 discriminates the input signals. If it is determined that the signal is not the input signal transmitted by the in-car button panels 100 or the up/down button panels 200 but the operation reference registration request signal input by the operator, the input signal discriminator 410 transmits the operation reference registration request signal to the car assignment unit 420 for requesting the operation reference registration of the elevator cars in every hoistway 1.

The information on the loads of the elevator cars 300-1 and 300-2 is collected by the load sensors 332 installed at the bottoms of the elevator cars 300-1 and 300-2, and the information on the interval between the elevator cars 300-1 and 300-2 are collected by the distance sensors installed on the top or bottom of the elevator cars 300-1 and 300-2. The car assignment unit 420 assigns the elevators cars for the calls on the basis of the information on the loads of the elevator cars 300-1 and 300-2 and the interval between the elevator cars 300-1 and 300-2.

At step S720, the car assignment unit 420 analyses the signal input by the operator, extracts assignment information from the signal, and sets a assignment reference for the hoistways 1 and the elevator cars 300-1 and 300-2.

Here, the assignment priorities of the elevator cars 300-1 and 300-2 are determined on the basis of the running direction of the elevator cars, distances between the elevator cars and the target floor, and number of pushing buttons on the up/down button panel at each floor.

The information registered through the car assignment unit 420 on the basis of the operation reference is reflected for assigning the hoistway 1 and the elevator car and the assignment priority can be changed by the operator.

The elevator cars can be set such that one elevator car is assigned for long distance travels and the other is assigned for short distance travels.

Before controlling the travel speeds of the elevator cars (S740), it is required to calculate the loads of the elevator cars and the interval between the elevator cars (S730).

At step S740, the travel speed of the elevator cars are adjusted on the basis of their loads such that the heavily loaded elevator car travels at low speed with few or sporadic stops and the lightly loaded elevator car travels at high speed with frequently stops.

Preferably, the first elevator car 300-1 is assigned for the long distance travels, and the second elevator car 300-2 is assigned for the short distance travels. If it is detected, by the load sensor 332, that the loads of the elevator cars increase while traveling between the target floors, the travel speeds of the elevator cars are adjusted to decrease in consideration of the interval between the elevator cars, detected by distance sensor 334.

On the other hand, if it is detected, by the load sensor 332, that the loads of the elevator cars decrease, the travel speeds of the elevator cars are adjusted to increase in consideration of the interval between the elevator cars in a predetermined range.

### INDUSTRIAL APPLICABILITY

As described above, the elevator system of the present invention schedules multiple elevator cars for multiple calls on the basis of information obtained by analyzing various signals provided from button panels installed at the elevator cars and elevator entrances of a building, thereby improving operation efficiency of the elevator system.

Also, the elevator system of the present invention is advantageous since a target floor can be selected on an up/down button panel installed at an elevator entrance as well as on an in-car button panel.

Also, the elevator system of the present invention enables predicting change of loads to be onboard on the basis of signals input through in-car button panels installed in elevator cars and up/down button panels installed at elevator entrances, whereby it is possible to optimally schedule stops of the elevator cars.

1. An elevator system comprising:
at least one hoistway; and
at least two elevator cars operating independently in the hoistway.

2. The elevator system of claim 1, wherein the hoistway houses a pair of first and second elevator cars, the first car being driven by a first driving unit installed at a roof of the hoistway, and the second elevator car is driven by a second driving unit installed at a bottom of the first elevator car.

3. The elevator system of claim 1, further comprising at least one driving unit installed at a roof wall of each hoist way for driving the elevator cars independently.

4. The elevator system of claim 2, further comprising:
a sensing unit installed at each elevator car for sensing a load and speed of the elevator car and interval between the elevator cars housed in the same hoistway;
an up/down button panel installed at each elevator entrance for allowing input of a target floor number;
an in-car button panel installed at each elevator car for allowing input of a target floor number; and
a main control unit for scheduling the elevator cars on the basis of signals input through the up/down button panel, the in-car button panel, and the sensing unit.

5. The elevator system of claim 4, further comprising a passenger recognition module installed on the up/down button panel for identifying expected passengers using unique human characteristics and estimating a number of the expected passengers waiting at a same floor by counting inputs by different expected passengers.

6. The elevator system of claim 5, wherein the main control unit controls landings of the passengers at specific floors on the basis of weights previously assigned to the passengers.

7. The elevator system of claim 4, wherein each of the in-car button panel and up/down button panel comprises a plurality of numeric buttons, a combination of at least one of the numeric buttons generates a target floor number.

8. The elevator system of claim 4, wherein the in-car button panel comprises a plurality of floor number buttons that are selectively activated according to a passenger identity collected by additional passenger input.

9. The elevator system of claim 4, wherein the sensing unit comprises: a load sensor installed at a bottom of the elevator car for sensing the load of the elevator car;
a speed sensor installed on an outside wall of the elevator car for sensing travel speed of the elevator car; and
a distance sensor for sensing a distance between the elevator cars in the same hoistway.

10. The elevator system of claim 4, wherein the main control unit collects information on get-on and get-off floors from signals input through the in-car and up/down button panels and information on loads of the elevator cars, a distance between the elevator cars in the same hoistway, and travel speeds of the elevator cars, computes stop and non-stop floors of each elevator car on the basis of the collected information, and generates control signals for operating the elevator cars in accordance with a preset scheduling algorithm.

11. The elevator system of claim 10, wherein the main control unit assigns the first elevator car for the target floors far from a homing floor and the second elevator car for the target floors relatively near from the home floor, in running directions.

12. The elevator system of claim 10, wherein the main control unit assigns the elevator car having the lowest load to the target floor from which the greatest number of inputs is transmitted.

13. The elevator system of claim 4, wherein the up/down button panel comprises a time input module for enabling input of arrival time.

14. The elevator system of claim 4, wherein the main control unit controls the elevator cars to operate in specific sections of the building, respectively.

15. The elevator system of claim 14, further comprising an auxiliary input panel having a plurality of Braille numeric, confirm, and cancel buttons allowing generation of floor number composed of at most 4 digits.

16. An elevator system comprising:
an up/down button panel installed at each elevator entrance for allowing input of a target floor number; and
an in-car button installed at each elevator car for allowing input of a target floor number, wherein
at least one of the up/down button panel and the in-car button panel is configured to input the floor number by a combination of at least one of single digit numeric buttons.

17. A method for controlling a group elevator system including at least one hoistway housing at least one elevator car having an in-car button panel and a sensing unit and an up/down button panel installed at each elevator entrance, comprising:
receiving signals input through the in-car and up/down button panels and the sensing unit;
extracting information on loads of the elevator cars, a distance between the elevator cars in the same hoistway, and target floors from the signals;
assigning the hoistways and elevator cars for target floors on the basis of the information; and
adjusting travel speeds of the elevator cars in accordance with a variations of the loads of the elevator cars and the distance between the elevator cars.

18. The method of claim 17, further comprising:
setting an arrival time for each target floor on the basis of signals received from the in-car button panel; and
announcing the arrival at the target floor.

19. The method of claim 18, wherein receiving signals comprises counting inputs at the same up/down button panel and inputs for the same target floor.

20. The method of claim 17, wherein assigning the hoistways and elevator cars comprises:
determining the floor at which the most inputs are counted through the up/down button panel and for which the most inputs are counted through the in-car button panel as a preferential target floor; and
assigning the hoistways and elevator cars to the preferential target floor at first.

21. The method of claim 17, wherein assigning the hoistways and elevator cars comprises assigning one of the elevator cars for the target floors far from a homing floor and the other for the target floors near from the homing floor, the elevator cars running in the same hoistway in the same direction.

22. The method of claim 17, wherein adjusting travel speeds comprises detecting variations of the loads of the elevator cars and the distance between the elevator cars during the operation.

23. The elevator system of claim 3, further comprising:
a sensing unit installed at each elevator car for sensing a load and speed of the elevator car and interval between the elevator cars housed in the same hoistway;
an up/down button panel installed at each elevator entrance for allowing input of a target floor number;
an in-car button panel installed at each elevator car for allowing input of a target floor number; and
a main control unit for scheduling the elevator cars on the basis of signals input through the up/down button panel, the in-car button panel, and the sensing unit.

24. The elevator system of claim 23, further comprising a passenger recognition module installed on the up/down button panel for identifying expected passengers using unique human characteristics and estimating a number of the expected passengers waiting at a same floor by counting inputs by different expected passengers.

25. The elevator system of claim 24, wherein the main control unit controls landings of the passengers at specific floors on the basis of weights previously assigned to the passengers.

26. The elevator system of claim 23, wherein each of the in-car button panel and up/down button panel comprises a plurality of numeric buttons, a combination of at least one of the numeric buttons generates a target floor number.

27. The elevator system of claim 23, wherein the in-car button panel comprises a plurality of floor number buttons that are selectively activated according to a passenger identity collected by additional passenger input.

28. The elevator system of claim 23, wherein the sensing unit comprises: a load sensor installed at a bottom of the elevator car for sensing the load of the elevator car;
a speed sensor installed on an outside wall of the elevator car for sensing travel speed of the elevator car; and
a distance sensor for sensing a distance between the elevator cars in the same hoistway.

29. The elevator system of claim 23, wherein the main control unit collects information on get-on and get-off floors from signals input through the in-car and up/down button panels and information on loads of the elevator cars, a distance between the elevator cars in the same hoistway, and travel speeds of the elevator cars, computes stop and non-stop floors of each elevator car on the basis of the collected information, and generates control signals for operating the elevator cars in accordance with a preset scheduling algorithm.

30. The elevator system of claim 29, wherein the main control unit assigns the first elevator car for the target floors far from a homing floor and the second elevator car for the target floors relatively near from the home floor, in running directions.

31. The elevator system of claim 29, wherein the main control unit assigns the elevator car having the lowest load to the target floor from which the greatest number of inputs is transmitted.

32. The elevator system of claim 23, wherein the up/down button panel comprises a time input module for enabling input of arrival time.

33. The elevator system of claim 23, wherein the main control unit controls the elevator cars to operate in specific sections of the building, respectively.

34. The elevator system of claim 33, further comprising an auxiliary input panel having a plurality of Braille numeric, confirm, and cancel buttons allowing generation of floor number composed of at most 4 digits.
